(19) United States
(12) Patent Application Publication
(10) Pub. No.: US 2019/0343598 A1
(43) Pub. Date: Nov. 14, 2019

(54) CONTROLLING AN ORIENTATION OF A TOOL IN RELATION TO A WORK PART

(71) Applicant: UNIVERSITÄT BASEL, Basel (CH)

(72) Inventors: Bruno KNOBEL, Laufen (CH); Stefan STÜBINGER, Binningen (CH)

(21) Appl. No.: 16/466,756

(22) PCT Filed: Dec. 5, 2017
(86) PCT No.: PCT/EP2017/081480

§ 371 Date: Jun. 5, 2019

(30) Foreign Application Priority Data
Dec. 6, 2016 (EP) 16202367.5

(51) Int. Cl. A61C 1/08

(52) U.S. Cl. CPC A61C 1/082

(57) ABSTRACT

A method of enabling a control of an orientation of a tool, particularly a dental drill, in relation to a work part, particularly a jaw, is disclosed. The method includes mounting a work part inertial system unit stationary to the work part; mounting a tool inertial system unit stationary to the tool; obtaining a digital image of the work part; defining three reference spots on the digital image of the work part wherein the three reference spots are distant from each other and stationary in relation to the work part; defining a target orientation of the tool on the digital image of the work part wherein the target orientation is definite with respect to a reference plane comprising the three reference spots; and referencing the tool inertial system unit to the three reference spots of the work part.

### TECHNICAL FIELD

The present invention relates to a method according to the preamble of independent claim 1 and more particularly to a kit, a tooling system and methods of manufacturing such a tooling system and such a kit.

Such control methods comprising mounting a work part inertial system unit stationary to a work part; mounting a tool inertial system unit stationary to a tool; and obtaining a digital image of the work part, can be used for enabling an accurate control of an orientation of the tool in relation to the work part.

### BACKGROUND ART

In applications where an accurate tooling of a work part is desired there are many measures used for precisely locating and orientating the tool to the work part. Particularly in medical or surgical applications precise tooling can be crucial for the success of an intervention.

For achieving a precise tooling there have systems been established which automatically evaluate the spatial relationship of the tool such as a saw, a chisel or a drill to a work part such as a bone or another human or animal hard tissue. Thereby, such systems often use sensors mounted to the work part and the tool which gather and deliver data about the location, orientation and motion of the work part and the tool. In order to interrelate these data sensors have to be referenced to each other typically by means of a reference or absolute coordinate system.

For referencing the work part and the tool to each other known systems typically use more or less cumbersome auxiliary equipment such as physical coordinate axes fixed to the tool and the work part. Such coordinate axes, for example, usually have three arms extending in three perpendicular directions wherein at least four points such as the common corner point and the three end points of the arms are detectable.

A system particularly intended for dental drilling applications is described in U.S. Pat. No. 6,000,939 A. This system comprises two acceleration sensors which are fixed to the patient and to the tool. The acceleration sensors provide X-, Y- and Z-signals which are interrelated by a controller of the system. The controller is programmed to evaluate position and orientation of the acceleration sensors to each other and to interrupt operation of the drill if a deviation of a predefined relation is detected. For establishing the position of a drill bit in relation to bone structure of the patient the system comprises a template with a metallic tubing. The template is fixed to the teeth of the patient, e.g. by the patient biting and thereby holding the template, and an X-ray image is generated in which the tubing and the bone structure is visible or identifiable. On the image the correct drilling position and orientation are defined. For referencing the drill bit to the bone structure the drill bit is arranged through the tubing. Orientation and position of the drill bit in relation to the bone structure can now be evaluated.

Even though the system described in U.S. Pat. No. 6,000,939 A allows for a more convenient operation it still has essential draw backs. For example, the system requires to provide an X-ray image of bone structure together with the template having the tubing for designing the position and orientation of the drilling. Thereby, beyond others, it is required that the template will be arranged exactly the same when acquiring the X-ray image for the intervention planning as when referencing the drill bit to the bone structure, i.e. during or shortly before the intervention.

Therefore, there is a need for a comparably conveniently operatable system or method allowing to accurately controlling an orientation of a tool such as a drill in relation to a work part such as a jaw.

### Disclosure of the Invention

According to the invention this need is settled by a method as it is defined by the features of independent claim 1, by a tooling system as it is defined by the features of independent claim 7 and by a method as it is defined by the features of independent claims 15. Preferred embodiments are subject of the dependent claims.

In particular, the invention deals with a method of enabling a control of an orientation of a tool in relation to a work part (control method). The tool can particularly be a dental drill and the work part a jaw. The control method generally comprises the steps of: mounting a work part inertial system unit stationary to the work part; mounting a tool inertial system unit stationary to the tool; and obtaining a digital image of the work part. It further comprises the steps of: defining three reference spots on the digital image of the work part wherein the three reference spots are distant from each other and stationary in relation to the work part or the work part inertial system unit; defining a target orientation of the tool on the digital image of the work part wherein the target orientation is definite with respect to a reference plane comprising the three reference spots; and referencing the tool inertial system unit to the three reference spots of the work part.

The target orientation in connection with the control method can particularly be the orientation the tool or a portion thereof such as a drill bit is to be placed for an intended tooling of the work part. In particular, when the tool is a drill such as a dental drill the target orientation can be the orientation of the drill bit to be forwarded into the work part or a bone or the jaw bone.

The jaw can particularly be a jaw of a human or animal being which typically comprises a jaw bone and, as the case may be, teeth rooted in the jaw bone.

The term “digital image” can relate to a set of data representing the work part. Thereby, the digital image can particularly be a visual representation of the work part. It can be an image obtained by X-ray, by optical coherence tomography (OCT) or by cone beam computed tomography (CBCT). When obtaining the digital image the work part inertial system unit or at least parts thereof such as a mounting structure or bracket thereof advantageously are stationary mounted to the work part already. For a better visibility on the digital image a marker such as an X-ray opaque marker can be applied when obtaining the digital image. Like this, the position and orientation of the work part inertial system unit relative to the work part is defined on the digital image. Alternatively, the work part inertial system unit is mountable to the work part in a specific position and orientation to the work part only such that its position and orientation is given on the digital image.

The three reference spots can be spots or landmarks of the work part which are comparably easy to identify and/or which are characteristic for the work piece. For example, if the work piece is a jaw the spots can be located in scissures of some or of three teeth. The spots themselves can be one- or two-dimensional portions of such landmarks of the work part.

The term “defining” in connection with the three reference spots and the target orientation can relate to a user specifying the three spots or target orientation by means of a computer. For example, the computer can be adapted to display a visual representation of the digital image on a screen and to provide electronic tools for specification. Then a user can manipulate these electronic tools for specifying the three reference spots and the target orientation, e.g., by using a computer mouse and/or a keyboard as input devices.

The inertial systems advantageously are embodied to provide absolute positions rather than relative positions in relation to each other. Like this, the precision, independence and user-friendlyness of the system can be enhanced. Further, in preferred embodiments, the inertial systems are embodied as microelectromechanical systems (MEMS). Such MEMS allow for using established technologies in a comparably small environment. Additionally, such MEMS allow for providing the inertial systems less fault-prone. For example, it can be prevented that components which may be disadvantageous for the operation, such as components generating magnetic fields like magnet field sensors, have to be used.

The inertial systems can have a housing hermetically sealing its electronics. The housing can be cylindrical, cubical, cuboid or the like. It can be sterilizable. For energizing the electronic components the inertial systems can have a battery such as an advantageously exchangeable mono-cell battery. Further, they can comprise an identification coding allowing the inertial systems and/or a control unit to identify which inertial systems belong together. The size of the inertial systems can be in range of 5 mm to 20 mm or about 15 mm long cube. The inertial systems can be equipped with a fixing structure allowing the inertial systems to be mounted to the tool or work part. Such a fixing structure can have clamping means, magnetic means, plugging means, screwing means, a bracket or the like.

The term “stationary” in connection with the inertial system units can particularly relate to an immovable arrangement. In particularly, the work part inertial system unit and the tool inertial system unit can be stationary in relation to the work part or the tool by being clamped, adhered, clipped to the work part or the like. Thereby, stationary does not mean that the inertial system units mandatorily are permanently fixed to the work part or tool. Rather, they can be releasably mounted. Important is that they are fixed in orientation and eventually position during referencing and during controlling of the intervention.

With the method according to the invention an accurate operation of the tool on the work part can be achieved. Particularly, in applications where only the orientation of the tool is to monitor the method allows to precisely and easily providing the tool in an operable status and to accurately controlling operation of the tool on the work part. For example, in dental drilling usually the location where the drill bit is to be applied to the bone can efficiently be found and handled by the surgeon. Thus, controlling the orientation of the drill usually is sufficient for ensuring an accurate provision of a drill hole into the jaw bone.

By mounting the inertial system units to the tool and to the work part and by referencing the inertial system units to each other via the three reference spots, the tool and the work part can precisely be interrelated in a convenient and efficient manner. Particularly, for achieving control of the orientation of the tool it is sufficient to know the orientation of the tool with respect to a plane fixedly designed to the work part. And such a plane can efficiently be generated by the three reference spots. Thus, the orientation of the tool can particularly efficiently be referenced in relation to the work part such that an accurately controlled operation can be provided.

Thus, the control method according to the invention allows for a comparably convenient operation for an accurate control of the orientation of the tool in relation to the work part.

In an embodiment of a control method other than the control method according to the invention the same principle can be applied without providing an inertial system unit to the work part. In particular, such embodiment of the control method may comprise the following steps: mounting a tool inertial system unit stationary to a tool; obtaining a digital image of a work part; defining three reference spots on the digital image of the work part wherein the three reference spots are distant from each other and stationary in relation to the work part; defining a target orientation of the tool on the digital image of the work part wherein the target orientation is definite with respect to a reference plane comprising the three reference spots; and referencing the tool inertial system unit to the three reference spots of the work part. Such an adapted control method may be particularly beneficial in applications where the work part is fixedly installed such that its orientation is predefined. For example, it can be appropriate in a surgical application where the body part involved is fixed.

Preferably, each of the work part inertial system unit and the tool inertial system unit comprises a six or nine degrees of freedom sensing equipment. With such a sensing equipment linear accelerations and/or angular velocities can be measured. Having a known starting position and orientation such sensors allow for measuring the effective orientation and position, e.g. of a reference coordinate system, relative to the starting position and orientation at any time.

The six or nine degrees of freedom sensing equipment preferably comprises an accelerometer, a gyroscope, a magnetometer or any combination thereof. The accelerometer particularly can be an acceleration sensor sensing or measuring acceleration data. The magnetometer particularly can be a gravitation sensor sensing or measuring gravity data. The gyroscope particularly can be a rotational sensor sensing or measuring rotation data. Such inertial system units allow for an efficient and accurate data provision for controlling the orientation of the tool in relation to the work part. Other possible devices comprised by the sensing equipment could be ultra sonic sensors or radar sensors.

Preferably, referencing the tool inertial system unit to the three reference spots of the work part comprises the tool contacting the reference spots on the work part. For such referencing contacting can be performed by the tool touching each of the three reference spots and obtaining information of the tool inertial system unit during each touch. Such referencing allows for a particularly simple and convenient operation. Particularly, requiring a specific auxiliary device for referencing can be prevented. Rather the reference plane can virtually be generated from the data of the three referencing spots.

Thereby, contacting two subsequent of the reference spots on the work part with the tool preferably is performed within less than about 5 seconds, within less than about 3 seconds or within less than about 1 second. Such a method allows for preventing any inaccuracies due to motions of the work part between contacting of the subsequent spots.

Thereby, the tool inertial system unit preferably provides reference data for each of the reference spots when contacting the reference spots on the work part. For example, the tool can be equipped with a button which is pressed while contacting a single reference spot. When the button is pressed the tool inertial system unit gathers the reference data which are forwarded for evaluation. The reference data can comprise measured data provided by the six or nine degrees of freedom sensing equipment such as by the accelerometer, the gyroscope and/or the magnetometer.

In another embodiment defining the three reference spots on the digital image of the work part comprises obtaining a template having a placing structure for contacting the work part at the three reference spots and an aligning structure adapted for aligning the tool in a predefined orientation. Referencing by means of such a template allows for precisely aligning the tool to the work part wherein known techniques can be used. Building templates is a known technique in dentistry which can be used for referencing within the method according to the invention. For example, the template can be manufactured by 3D-printing.

Thereby, referencing the tool inertial system unit to the three reference spots of the work part preferably comprises placing the template on the work part such that the placing structure contacts the three reference spots and positioning the tool on the aligning structure of the template. Also, the aligning structure preferably is definite with respect to the template. The aligning structure can, e.g., be a sleeve adapted to receive the tool and particularly a drill bit of the dental drill in a predefined orientation.

The method according to the invention can be a method other than a method for treatment of the human or animal body by surgery or therapy, or a diagnostic method practiced on the human or animal body.

A further aspect of the invention relates to a tooling system which comprises a tool particularly a dental drill, a work part inertial system unit, a tool inertial system unit and a control unit. The work part inertial system unit is stationary mounted to the work part. The tool inertial system unit is stationary mounted to the tool. The control unit is arranged and configured to: obtaining a digital image of the work part; defining three reference spots on the digital image of the work part wherein the three reference spots are distant from each other and stationary in relation to the work part inertial system unit; defining a target orientation of the tool on the digital image of the work part wherein the target orientation is definite with respect to a reference plane comprising the three reference spots; and referencing the tool inertial system unit to the three reference spots of the work part.

The term “arranged and configured to” in connection with the control unit can relate to the control unit being embodied to be capable of performing certain functions. Thereby, the control system can be equipped and provided with the necessary structure such as interfaces to the inertial system units, a central processing unit (CPU), a memory, a data storage and the like (arranged). Furthermore, it or its structure can be adjusted, adapted or programmed to perform the necessary functions such as defining the three reference spots or referencing the tool (configured).

The control unit can particularly be a computer such as a desktop computer, a laptop, a tablet, a smartphone or the like programmed in an appropriate manner.

Alternatively, the control unit or portions thereof can be integrated in any of the inertial systems or in the tool.

For obtaining the digital image of the work part the control unit can be equipped with an interface structure. The interface structure can comprise a connector for establishing a data connection to an imaging device and an evaluation structure for evaluating data received from the imaging device via the connector.

For defining the three reference spots and the target orientation on the digital image the control unit can be equipped with or connected to peripherals such as a monitor or screen, a computer mouse, a pedal, a touch sensitive screen, an electronic pen, a trackball, a similar device or any combination thereof.

For referencing the tool inertial system unit the evaluation structure can involve an algorithm interrelating the orientation of the tool to the work part. Advantageously, the algorithm can be adapted to calculating the reference plane on the basis of the reference spots, correlating the target orientation to the reference plane and correlating the tool inertial system unit to the reference plane.

Such a tooling system allows for efficiently achieving and implementing the effects and benefits explained in connection with the control method according to the invention and its preferred embodiments as described above.

Preferably, the work part inertial system unit and/or the tool inertial system unit comprises a six or nine degrees of freedom sensing equipment. Thereby, the six or nine degrees of freedom sensing equipment preferably comprises an accelerometer, a gyroscope, a magnetometer or any combination thereof.

Preferably, each of the control unit, the work part inertial system unit and the tool inertial system unit comprise a communication interface wherein the control unit is connected to the work part inertial system and the tool inertial system via the communication interfaces. Such interfaces allow for efficiently transferring data from the sensing equipment to the control unit and, as the need may be, from the control unit to the sensing equipment and/or between the inertial system units. Thereby, the communication interfaces preferably are wireless communication interfaces. This allows for a convenient communication unhindered by any cables, plugs or the like. The term “wireless communication” in this context can relate to any appropriate standard or non-standard wireless communication such as Bluetooth, WiFi or the like.

Preferably, the control unit is arranged and configured to obtain a set of reference data provided by the tool inertial system unit for each of the reference spots when the tool contacts the reference spots on the work part. Such data sets can efficiently be evaluated by the control unit.

Preferably, the tool inertial system unit comprises a trigger structure which is adapted to provide a set of reference data when being activated. The trigger structure can be physically integrated in the tool inertial system unit or it can be separate thereof. It can, e.g., comprise a button to be pushed, a pedal to be stepped on, a microphone unit to be activated by a specific sound or the like. Such trigger structure allows the operator to initiate provision of reference spot data. Thus, as soon as the tool is arranged in an appropriate position, i.e. at one of the reference spots, he can initiate the control unit to obtain data from tool inertial system unit and the work part inertial system unit by activating the trigger structure.

The tooling system can have an optical or acoustical feedback arrangement providing information about the orientation of the tool. Such feedback arrangement can comprise a loudspeaker adapted to generate a particular sound depending on the orientation of the tool in relation to the target orientation. Alternatively or additionally, the feedback arrangement can comprise an array of light emitting diodes (LED) visibly indicating the orientation of the tool with respect to the target orientation. Alternatively or additionally, the feedback arrangement can comprise a display on which the orientation is shown relative to the target orientation in real time. Preferably, the feedback arrangement is embodied by the inertial system unit comprising a light source which is adapted to emit a light beam representing the target orientation of the tool. Such a feedback arrangement allows for efficiently monitoring the actual orientation of the tool in relation to the target orientation. Like this, the operator can be assisted to hold the tool in the target orientation such that an accurate tooling can be achieved.

Preferably, the control unit is further arranged and configured to: obtaining orientation data provided by the tool inertial system; identifying an effective orientation of the tool by evaluating the orientation data; comparing the effective orientation to the target orientation; and initiating a warning signal if a deviation between the effective orientation and the target orientation exceeds a predefined threshold. Such a control signal allows for warning the operator when the tool is not sufficiently aligned to the target orientation such that he can take appropriate measures.

Thereby, the tool inertial system unit preferably comprises an alarm wherein the control unit is arranged and configured to trigger the alarm for initiating the warning signal. The alarm can, e.g., comprise a lamp or a speaker or the like. Alternatively, the control unit can be adapted to automatically shut down operation of the tool once the deviation of the tool with regard to the target orientation is inappropriate.

Another further aspect of the invention relates to a kit comprising a work part inertial system unit, a tool inertial system unit and a control computer program product, wherein the work part inertial system unit is arranged to be stationary mounted to a work part; the tool inertial system unit is arranged to be stationary mounted to a tool; and the control computer program product comprises a code structure arranged to, when being executed on a computer, the computer to obtain a digital image of the work part; define three reference spots on the digital image of the work part wherein the three reference spots are distant from each other and stationary in relation to the work part inertial system unit; define a target orientation of the tool on the digital image of the work part wherein the target orientation is definite with respect to a reference plane comprising the three reference spots; and reference the tool inertial system unit to the three reference spots of the work part.

Such a kit allows for efficiently achieving and implementing the effects and benefits explained in connection with the control method according to the invention and the tooling system according to the invention and their preferred embodiments as described above.

Preferably, the work part inertial system unit and/or the tool inertial system unit of the kit comprises a six or nine degrees of freedom sensing equipment. Thereby, the six or nine degrees of freedom sensing equipment preferably comprises an accelerometer, a gyroscope, a magnetometer or any combination thereof.

Preferably, each of the work part inertial system unit and the tool inertial system unit of the kit comprise a communication interface. Thereby, the communication interfaces preferably are wireless communication interfaces.

Preferably, the code structure of the control computer program product of the kit is arranged to, when being executed on the computer, the computer to obtaining a set of reference data provided by the tool inertial system unit for each of the reference spots when the tool contacts the reference spots on the work part.

Preferably, the tool inertial system unit of the kit comprises a trigger structure which is adapted to provide a set of reference data when being activated.

The tool inertial system unit of the kit can comprise a display for indicating an effective orientation of the tool with respect to the target orientation. Such display can, e.g., be a plurality of light emitting diodes which can be provided in the work part inertial system unit. It preferably comprises a light source which is arranged to emit a light beam representing the target orientation of the tool.

Preferably, the code structure of the control computer program product of the kit is arranged to, when being executed on the computer, the computer to: obtaining orientation data provided by the tool inertial system; identifying an effective orientation of the tool by evaluating the orientation data; comparing the effective orientation to the target orientation; and initiating a warning signal if a deviation between the effective orientation and the target orientation exceeds a threshold.

Thereby, the tool inertial system unit of the kit preferably comprises an alarm wherein the control unit is arranged and configured to trigger the alarm for providing the warning signal. The alarm can, e.g., comprise a lamp or a speaker or the like.

Still another further aspect of the invention relates to a method of manufacturing a tooling system as described above (system manufacturing method). The system manufacturing method comprises the steps of: equipping a work part inertial system unit with a mounting structure adapted to be stationary mounted to a work part; equipping a tool inertial system unit with a mounting structure adapted to be stationary mounted to a tool; and arranging and configuring a control unit to obtaining a digital image of the work part; defining three reference spots on the digital image of the work part wherein the three reference spots are distant from each other and stationary in relation to the work part inertial system unit; defining a target orientation of the tool on the digital image of the work part wherein the target orientation is definite with respect to a reference plane comprising the three reference spots; and referencing the tool inertial system unit to the three reference spots of the work part. Such a system manufacturing method allows for efficiently setting up a tooling system as described above thereby achieving the effects and benefits involved.

Still another further aspect of the invention relates to a method of manufacturing a kit as described above (kit manufacturing method). The kit manufacturing method comprises the steps of: equipping a work part inertial system with a mounting structure adapted to be stationary mounted to a work part; equipping a tool inertial system unit with a mounting structure adapted to be stationary mounted to a tool; and providing a control computer program product with a code structure arranged to, when being executed on a computer, the computer to obtain a digital image of the work part; define three reference spots on the digital image of the work part wherein the three reference spots are distant from each other and stationary in relation to the work part inertial system unit; define a target orientation of the tool on the digital image of the work part wherein the target orientation is definite with respect to a reference plane comprising the three reference spots; and reference the tool inertial system unit to the three reference spots of the work part. Such a kit manufacturing method allows for efficiently setting up a kit as described above thereby achieving the effects and benefits involved.

### BRIEF DESCRIPTION OF THE DRAWINGS

The tooling system, kit and control method according to the invention are described in more detail herein below by way of exemplary embodiments and with reference to the attached drawings, in which:

FIG. 1 shows a first embodiment of a kit according to the invention and a first embodiment of a tooling system according to the invention;

FIG. 2 shows a jaw to be treated by a first embodiment of a control method according to the invention involving the kit and the tooling system of FIG. 1;

FIG. 3 shows the kit and tooling system of FIG. 1 in operation;

FIG. 4 shows a tool of a second embodiment of a kit according to the invention and a second embodiment of a tooling system according to the invention used in a second embodiment of a control method according to the invention;

FIG. 5 shows a third embodiment of a kit according to the invention and a third embodiment of a tooling system according to the invention;

FIG. 6 shows the kit and tooling system of FIG. 5 in a referencing step of a third embodiment of a control method according to the invention; and

FIG. 7 shows a template of a fourth embodiment of a kit according to the invention and a fourth embodiment of a tooling system according to the invention.

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

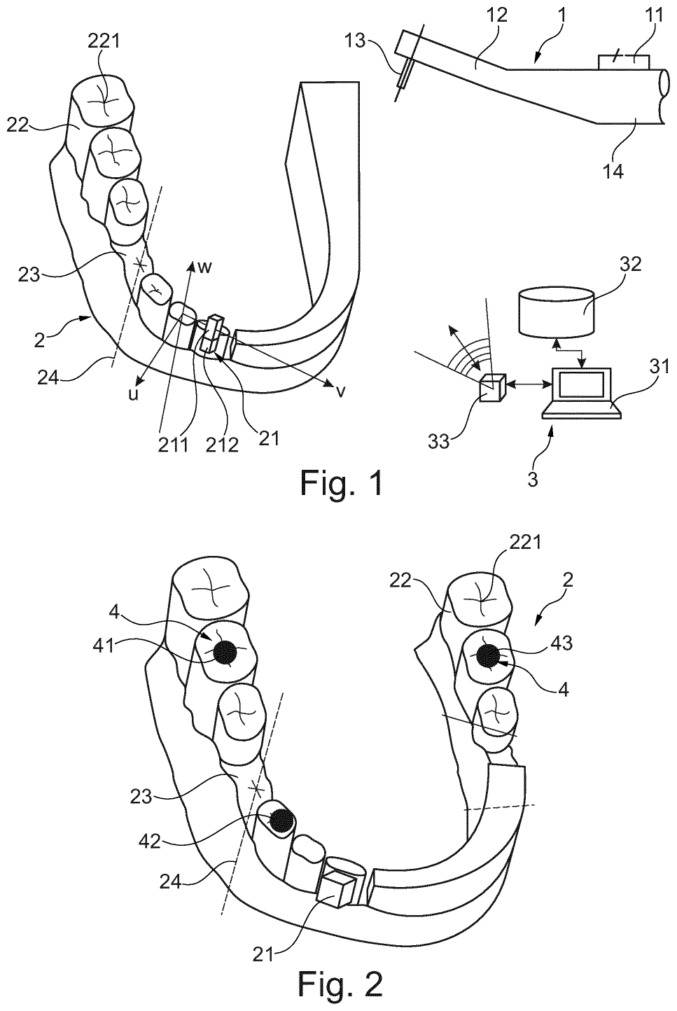

FIG. 1 shows a first embodiment of a kit according to the invention comprising jaw inertial system unit 21 as work part inertial system unit, a drill inertial system unit 11 as tool inertial system unit and a software as a control computer program product. The kit is used to implement a first embodiment of a tooling system according to the invention comprising a dental drill 1 as tool, a control unit 3, the jaw inertial system unit 21 and the drill inertial system unit 11.

The control unit 3 has a laptop computer 31 on which the software of the kit is executed. The laptop computer 31 is connected to a wireless adapter 33 for wireless communication with the inertial system units 11, 21 and to an external data storage 32.

The jaw inertial system unit 21 is stationary mounted to a jaw 2 of a patient. For this, it has a tooth clamp 212 which is attached to a labial one of teeth 22 of a jaw 2. Particularly the buccal teeth 22 have scissures 221. The jaw inertial system unit 21 further has a six or nine degrees of freedom (DOF) sensing equipment 211 with an accelerometer, a gyroscope and a magnetometer. It further is equipped with a wireless communication interface arranged to communicate with the wireless adapter 33 of the control unit 3.

The drill inertial system unit 11 is stationary mounted to a base portion 14 of the drill 1. The drill 1 further has an arm portion 12 extending from the base portion 14 to a head portion which holds a drill bit 13 in a rotatable fashion.

The tooling system and the kit are used in a first embodiment of a control method according to the invention. The software comprises a code structure which is arranged to adapt the laptop computer 31 to perform specific steps of the first control method.

In a preoperative planning step of the first control method a digital image of the jaw 2 is created, e.g. by an optical coherence tomography (OCT) or a cone beam computer tomography (CBCT) procedure. The digital image is obtained and displayed by the laptop computer 31 of the control unit 3. On the laptop computer 31 a target orientation 24 is defined on the digital image. The target orientation 24 represents an appropriate line or trajectory into which the drill bit 13 of the drill 1 is to be forwarded into a bone 23 of the jaw 2. Particularly, this is intended to generate a hole or channel into the bone 23 for placing or rooting a dental implant.

As can be seen in FIG. 2 within the control method three reference spots 4 are defined on the digital image of the jaw 2. A first reference spot 41 and a second reference spot 42 are located on teeth 22 besides a gap in the teeth 22 in which a dental restoration is to be positioned by means of the dental implant. A third reference spot 43 is located opposite the gap. In order to be easily identifiable in vivo the three reference spots 4 are defined by scissures 221 of the respective teeth 22.

The reference spots 4 are distant from each other and stationary in relation to the rest of the jaw 2. They define a reference plane which connects and comprises the three reference spots 4. The target orientation 24 is definite with respect to the reference plane. For referencing or calibrating the drill inertial system unit 11 to the three reference spots 4 the tip of the drill bit 13 contacts each of the reference spots 4 one after the other. When the drill bit 13 touches one of the reference spots 4 the operator pushes a button embodied on the drill inertial system unit 11. Thereby, the drill inertial system unit 11 and the jaw inertial system unit 21 provide reference data for the respective reference spot 4 and transfer the reference data to the control unit 3.

In order to prevent an inappropriate measurement deviation the contacting of two subsequent reference spots 4 has to be performed comparably fast. Preferably, contacting two subsequent of the reference spots 4 on the jaw 2 with the drill 1 is performed within less than about 1 second.

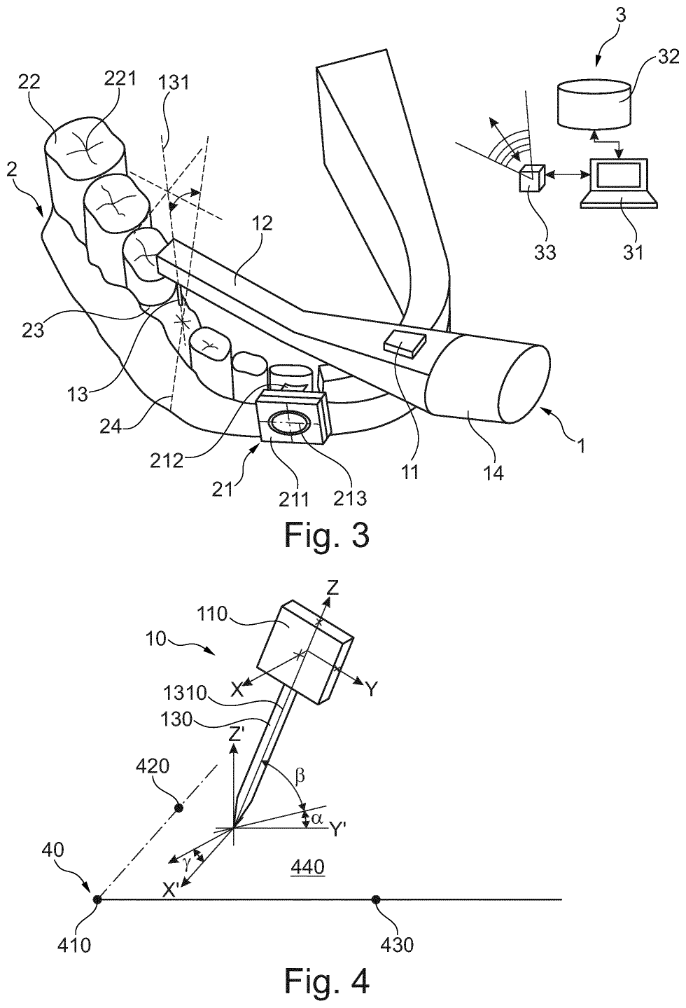

By means of the reference data the control unit 3 interrelates the drill 1 to the jaw 2. Thus, the drill 1 and the jaw 2 are calibrated to each other such that a relative orientation to each other is set and known. Once the drill 1 is referenced to the three reference spots 4 and thereby to the jaw 2 the drill 1 can be operated at a target location on the bone 23 as shown in FIG. 3. Thereby, the control unit 3 compares an effective orientation 131 of the drill bit 13 to the target orientation 24. It displays a deviation of the effective orientation 131 from the target orientation 24 on a screen of the laptop computer 31. Furthermore, in order to allow the view of the operator or surgeon to be focussed on the jaw 2, the jaw inertial system unit 21 has a set of LED 213 as a feedback arrangement which additionally show any deviation of the effective orientation 131 from the target orientation 24.

FIG. 4 shows a second embodiment of a kit according to the invention and a second embodiment of a tooling system according to the invention. Thereby, the kit and tooling system are illustrated in a simplified manner intended for describing some aspects of a second embodiment of a control method according to the invention. In particular, the aspects are intended to show the distinctness of an orientation 1310 to three reference spots 40. The aspects shown in FIG. 4 are analogously applicable and implemented in the first kit, first tooling system and first controlling method described above.

A drill 10 as tool comprises a drill bit 130 and is provided with a drill inertial system unit 110 as tool inertial system unit. The reference spots 40 comprise a first reference spot 410, a second reference spot 420 and a third reference spot 430 each being defined on a work part. The reference spots 40 are distant from each other and define a reference plane 440.

The drill inertial system unit 110 establishes a drill coordinate system with axes X, Y and Z. The reference plane 440 establishes a reference coordinate system with axes X′, Y′ and Z′. A six or nine DOF sensing equipment of the drill inertial system unit 110 allows for providing a control unit with reference data about the effective orientation 1310 of the drill. The control unit compares the effective orientation 1310 to the reference plane 440 and calculates deviations in any of the axis. In particular, it can calculate an effective X-angle y between the X-axis and the X′-axis, an effective Y-angle a between the Y-axis and the Y′-axis and an effective Z-angle β between the Z-axis and the Z′-axis. Like this, the effective orientation 1310 of the drill is in any instance distinctly known in relation to the reference plane 440 which in turn is distinct to the work part or jaw comprising the reference spots 40.

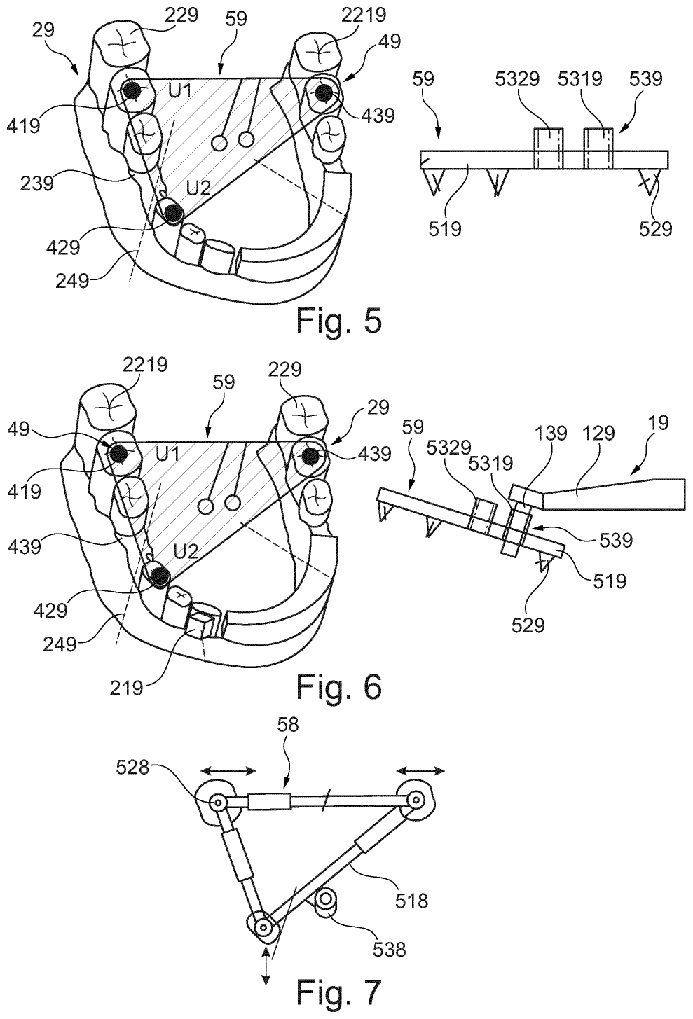

In FIG. 5 and FIG. 6 a third embodiment of a kit according to the invention comprising jaw inertial system unit 219 as work part inertial system unit, a drill inertial system unit as tool inertial system unit, a software as a control computer program product and a template 59. The kit is used to implement a third embodiment of a tooling system according to the invention comprising a dental drill 19 as tool and a control unit, the jaw inertial system unit 219 and the drill inertial system unit 119. These kit and system are intended for being used in a third embodiment of a control method according to the invention.

The jaw inertial system unit 219 is stationary mounted such as adhered to a jaw 29 of a patient and the drill inertial system is integral in a arm section 129 of the dental drill 19. Each of the inertial system units has a six or nine DOF sensing equipment and a wireless communication interface arranged to communicate with a wireless adapter of the control unit. The drill 19 has a head portion which holds a drill bit 139 in a rotatable fashion.

The template 59 has a base plate 519 with a top side and a bottom side. At the bottom side of the base plate 519 three stands 529 which downwardly project are arranged as placing structure. For aligning the drill bit 139 in a predefined orientation the template 59 further has two parallel sleeves 539 as aligning structure adapted extending through the base plate 519 and including a first sleeve 5319 and a second sleeve 5329. In the embodiment shown in FIGS. 6 and 7, the sleeves 539 are perpendicularly oriented to the base plate 519. However, other angles are also possible and might even be advantageous with regard to a convenient accessibility in the mouth of a patient. The template 59 is customized to the jaw of the patient. Particularly, it is shaped such that the stands 529 can be placed on reference spots 49 consisting of a first reference spot 419, a second reference spot 429 and a third reference spot 439. The reference spots 49 are defined in the scissures 2219 of three distant teeth 229 of the jaw 29.

The tooling system and the kit are used in the third control method wherein the software comprises a code structure which is arranged to adapt the control unit to perform specific steps of the control method similar as described above in connection with the control method of FIG. 1. In particular, if not differently described below the steps of the third control method correspond to the steps of the first control method.

As mentioned, the reference spots 49 are distant from each other and stationary in relation to the jaw 29. When being placed on the reference spots 49 the base plate 519 of the template defines a reference plane connecting the three reference spots 49. A target orientation of the drill bit to be applied is definite with respect to the reference plane.

As particularly visible in FIG. 6, for referencing or calibrating the drill inertial system unit to the three reference spots 49 the drill bit 139 is arranged into or through one of the sleeves 539 of the template 59 such as the first sleeve 5319 as shown in FIG. 6. In this situation, the drill inertial system unit and the jaw inertial system unit 219 provide reference data and transfer the reference data to the control unit.

Then, the drill bit 139 is arranged in the other one of the sleeves 539, i.e. the second sleeve 5329, and the drill inertial system unit and the jaw inertial system unit 219 provide further reference data being transferred to the control unit. The second sleeve 5329 can be an auxiliary sleeve for appropriate calibration of the drill 19. Instead of the second sleeve 5329, a recess, an indentation or a similar structure can be provided in the template 59 allowing the drill bit to be properly located at a well defined second spot in addition to the first sleeve 5319.

By means of the reference data and the further reference data the control unit interrelates the drill 19 to the jaw 29 such that the drill 19 and the jaw 29 are calibrated to each other. In particular, by providing the first and second sleeves 5319, 5329, data can be gathered which is sufficient for definitely defining or evaluating exact referencing of the drill 19. A relative orientation of the drill 19 and the jaw 29 to each other is thereby set and known.

In an alternative embodiment not shown in the Figs., the template can also be equipped with one single sleeve only. Such single sleeve is positioned and oriented to guide the drill in operation and, particularly, to assure correct locating and orienting of the drill. It can be embodied like a known drilling jig. Like this, the data provided by the drill and jaw inertial system units can be sufficient for accurately referencing the drill with respect to the jaw. In operation of the drill, the template is not required.

FIG. 7 shows another embodiment of a template 58 being comprised by a fourth embodiment of a kit according to the invention and a tooling system according to the invention. The tooling system and the kit are used in a third embodiment of control method according to the invention wherein a software of the kit comprises a code structure which is arranged to adapt a control unit of the tooling system to perform specific steps of the fourth control method similar as described above in connection with the third control method of FIG. 5 and FIG. 6. In particular, if not differently described below the steps of the fourth control method correspond to the steps of the third control method.

The template 58 comprises three rods 518 connected at their longitudinal ends to each other via a joint 528. The rods 518 are length adjustable and can be turned around the associated joints 528. The three joints 528 have bottom stands which form a placing structure of the template 58. Each of the rods 518 comprise two sections which telescopically connected to each other. By adjusting the length of the rods 519 and the angles at the joints 528 the template 58 can precisely be arranged to fit in three reference spots of a jaw. Like this, the template 58 can be adapted to the conditions of the jaw to be treated. At one of the rods 518 a sleeve 538 is fixedly mounted which is dimensioned to receiving a drill bit.

This description and the accompanying drawings that illustrate aspects and embodiments of the present invention should not be taken as limiting-the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the Figs. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively.

The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

A computer program may be stored/distributed on a suitable medium, such as an optical storage medium or a solid-state medium supplied together with or as part of other hardware, but may also be distributed in other forms, such as via the Internet or other wired or wireless telecommunication systems. In particular, e.g., a computer program can be a computer program product stored on a computer readable medium which computer program product can have computer executable program code adapted to be executed to implement a specific method such as the method according to the invention. Furthermore, a computer program can also be a data structure product or a signal for embodying a specific method such as the method according to the invention.

1-15. (canceled)

16. A method of enabling a control of an orientation of a tool, particularly a dental drill, in relation to a work part, particularly a jaw, comprising:
mounting a work part inertial system unit stationary to the work part;
mounting a tool inertial system unit stationary to the tool;
obtaining a digital image of the work part;
defining three reference spots on the digital image of the work part, wherein the three reference spots are distant from each other and stationary in relation to the work part;
defining a target orientation of the tool on the digital image of the work part, wherein the target orientation is definite with respect to a reference plane comprising the three reference spots; and
referencing the tool inertial system unit to the three reference spots of the work part.

17. The method of claim 16, wherein the work part inertial system unit and/or the tool inertial system unit comprises a six or nine degrees of freedom sensing equipment.

18. The method of claim 16, wherein referencing the tool inertial system unit to the three reference spots of the work part comprises the tool contacting the reference spots on the work part.

19. The method of claim 18, wherein contacting two subsequent of the three reference spots on the work part with the tool is performed within less than about 5 seconds, within less than about 3 seconds or within less than about 1 second.

20. The method of claim 18, wherein the tool inertial system unit provides reference data for each of the three reference spots when contacting the three reference spots on the work part.

21. The method of claim 16, wherein defining the three reference spots on the digital image of the work part comprises obtaining a template having a placing structure for contacting the work part at the three reference spots and an aligning structure adapted for aligning the tool in a predefined orientation.

22. The method of claim 21, wherein referencing the tool inertial system unit to the three reference spots of the work part comprises placing the template on the work part such that the placing structure contacts the three reference spots, and positioning the tool on the aligning structure of the template.

23. The method of claim 21, wherein the aligning structure is definite with respect to the template.

24. A tooling system comprising;
a tool, particularly a dental drill;
a work part inertial system unit;
a tool inertial system unit; and
a control unit,
wherein
the work part inertial system unit is configured to be stationary mounted to a work part,
the tool inertial system unit is configured to be stationary mounted to the tool, and
the control unit is arranged and configured to
obtain a digital image of the work part,
define three reference spots on the digital image of the work part, wherein the three reference spots are distant from each other and stationary in relation to the work part inertial system unit,
define a target orientation of the tool on the digital image of the work part, wherein the target orientation is definite with respect to a reference plane comprising the three reference spots, and
reference the tool inertial system unit to the three reference spots of the work part.

25. The tooling system of claim 24, wherein the work part inertial system unit and/or the tool inertial system unit comprises a six or nine degrees of freedom sensing equipment.

26. The tooling system of claim 24, wherein each of the control unit, the work part inertial system unit and the tool inertial system unit comprises a communication interface wherein the control unit is connected to the work part inertial system unit and the tool inertial system unit via the communication interfaces.

27. The tooling system of claim 26, wherein the communication interfaces are wireless communication interfaces.

28. The tooling system of claim 26, wherein the control unit is arranged and configured to obtain a set of reference data provided by the tool inertial system unit for each of the three reference spots when the tool contacts the three reference spots on the work part.

29. The tooling system of claim 24, wherein the tool inertial system unit comprises a trigger structure which is adapted to provide a set of reference data when being activated.

30. The tooling system of claim 24, further comprising an optical or acoustical feedback arrangement that is configured to provide information about the target orientation of the tool.

31. The tooling system of claim 24, wherein the tool inertial system unit comprises a light source which is adapted to emit a light beam representing the target orientation of the tool.

32. The tooling system of claim 24, wherein the control unit is arranged and configured to
obtain orientation data provided by the tool inertial system unit,
identify an effective orientation of the tool by evaluating the orientation data,
compare the effective orientation to the target orientation, and
initiate a warning signal if a deviation between the effective orientation and the target orientation exceeds a predefined threshold.

33. The tooling system of claim 32, wherein the tool inertial system unit comprises an alarm, and the control unit is arranged and configured to trigger the alarm for initiating the warning signal.

34. A method of manufacturing a tooling system according to claim 24 comprising:
equipping a work part inertial system unit with a mounting structure configured to be stationary mounted to a work part;
equipping a tool inertial system unit with a mounting structure configured to be stationary mounted to a tool; and
arranging and configuring a control unit to
obtain a digital image of the work part,
define three reference spots on the digital image of the work part, wherein the three reference spots are distant from each other and stationary in relation to the work part inertial system unit,
define a target orientation of the tool on the digital image of the work part, wherein the target orientation is definite with respect to a reference plane comprising the three reference spots, and
reference the tool inertial system unit to the three reference spots of the work part.
